(19) United States
(12) Patent Application Publication
(10) Pub. No.: US 2011/0047013 A1
(43) Pub. Date: Feb. 24, 2011

(54) MERCHANDISING AMPLIFICATION VIA SOCIAL NETWORKING SYSTEM AND METHOD

(76) Inventor: JAMES O. MCKENZIE III, Birmingham, AL (US)

Correspondence Address: W. EDWARD RAMAGE, COMMERCE CENTER SUITE 1000, 211 COMMERCE ST, NASHVILLE, TN, 37201, US

(21) Appl. No.: 12/785,410

(22) Filed: May 21, 2010

Related U.S. Application Data
(60) Provisional application No. 61/180,147, filed on May 21, 2009.

(51) Int. Cl. G06Q 30/00

(52) U.S. Cl. 705/14.4

(57) ABSTRACT

A system for engaging in online advertising and merchandising of products or brands in or through social networks, examples of which include MySpace.com and Facebook.com. Consumers select products that they are or may be interested in, and post them to a social network for feedback and voting. The items or products selected appear in the consumer's status update, and can be posted for viewing by their network of friends. By clicking on the link, the friends of the consumer can accept and visit the application. The application may then allow the friends to view the product or item selections on which the consumer is seeking feedback. The friends may submit comments or observations about the available selections, and also may be able to vote for the product or products that they prefer, or provide a rating on a particular product or products. All voting and comments may then be posted back to the consumer's social networking homepage, status update, and/or seller's product website along with the original message and link.

This application claims benefit of and priority to U.S. Provisional Application No. 61/180,147, filed May 21, 2009, by James O. McKenzie III, and is entitled to that filing date for priority. The specification, figures and complete disclosure of U.S. Provisional Application No. 61/180,147 are incorporated herein by specific reference for all purposes.

### FIELD OF INVENTION

This invention relates to a method and system for using social networking in conjunction with a company's website and online efforts to promote and sell merchandise and products.

### BACKGROUND OF THE INVENTION

Traditional forms of advertising over social networks are ineffective and usually result in a poor return on investment (ROI) for advertisers. Social networks are interactive environments where users are readily captivated within the social networking applications. Passive media tactics, like display ads, in an active media environment (e.g., social networks) are unable to engage users. In fact, users tend to ignore ads in these environments, making even the ad impressions useless. Thus, while traditional social network advertising remains costly, it often results in very poor performance. Because of the dichotomy between existing forms of static advertising and the interactive nature of social networks, there remains a market need for an advertising product that actively engages users within the social networking marketplace.

### SUMMARY OF INVENTION

In various embodiments, the present invention comprises a system that allows companies and other advertising entities to leverage word-of-mouth and viral marketing on or through social networks. Companies can reach targeted markets that they might not be able to connect with through traditional advertising, and increase exposure of a product or brand by enabling efficient, measurable distribution of product and brand information over social networks.

In one embodiment, the system enables the company to open a dialogue with a new set of potential buyers. It allows the company to become an active, meaningful participant in conversations occurring on social networks.

In another embodiment, the user can conduct real-time market research. The system captures and stores valuable feedback (e.g., comments, votes, likes, etc.) and demographic information. The system allows a company to effectively listen to the conversations occurring among participants in the target market in real time, thereby helping them to proactively evaluate and understand the attitudes and opinions of prospects and influencers. In one embodiment, a company-specific portal is provided to enable a business to access, view and analyze this detailed data. This information can help reduce the time between market research and product innovation.

In one embodiment, the use of a call-to-action button, “SHARE” button, or the like on a business website allows customers and potential customers to post rich product information to social networks and request feedback from family and friends with just a few clicks. This enables potential customers to pull product information into their close-knit social network in an accessible way, thereby facilitating open, honest conversations about a company's product, and building trust and confidence in a brand. By enabling consumers to easily and quickly evaluate a potential purchase with their network of influencers, the system can accelerate the buying process.

In another embodiment, the system comprises integrated contact and lead forms, and links to existing web application lead forms, to generate new leads over social networks. The system also encourages individuals to subscribe to opt-in marketing, thus ensuring interaction and engagement with potential customers.

In another embodiment, the system will allow for product reviews to be posted back to the product website to make these reviews and recommendations available to be viewed by the particular user and other users on the product website. In this capacity, a user may view reviews directly from the product website from individuals both in and out of their social network.

### DESCRIPTION OF THE DRAWINGS

FIG. 1 shows a view of a system in accordance with an embodiment of the present invention.

FIG. 2 shows a view of another system in accordance with an embodiment of the present invention.

FIGS. 3 through 9 shows views of exemplary points of access for an end-user.

FIG. 10 shows a view of an example of a Facebook interaction page in accordance with an embodiment of the present invention.

FIG. 11 shows a view of an exemplary report page.

### DETAILED DESCRIPTION OF EXEMPLARY EMBODIMENTS

In various exemplary embodiments, the system and associated methods of the present invention allow a company to engage in online efforts to advertise and merchandise their products or brand in or through social networks (examples of which include MySpace.com and Facebook.com), often in conjunction with a company website. Consumers select products that they are or may be interested in, and post them to a social network for feedback and voting.

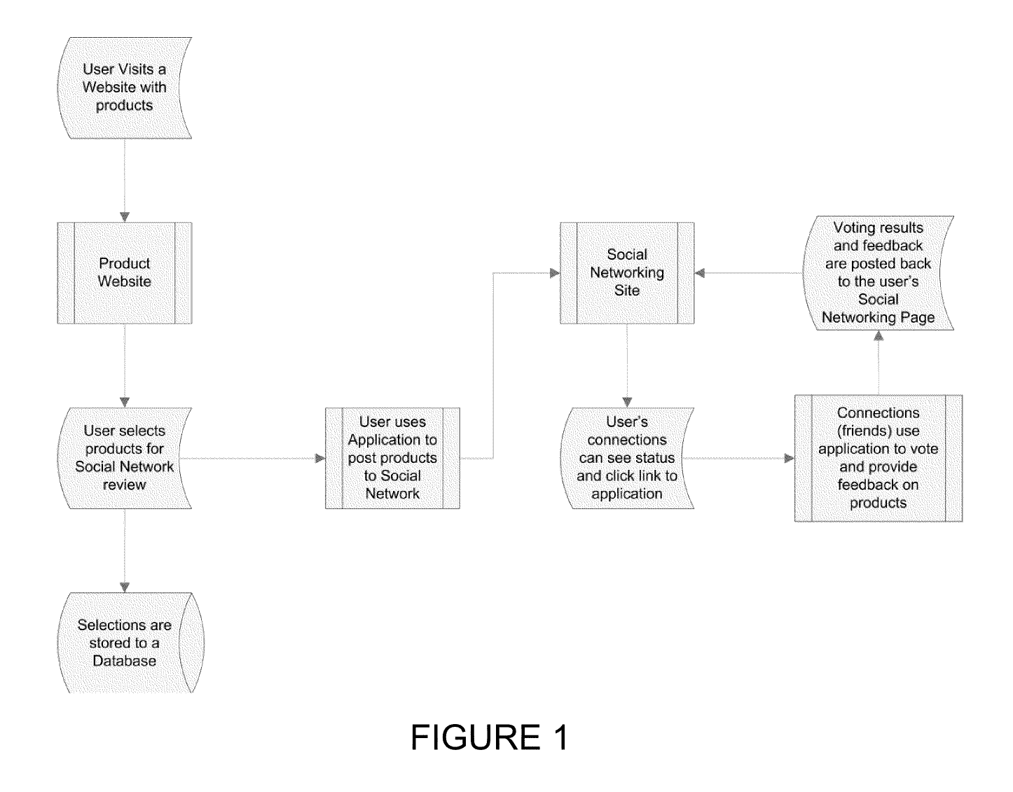

In one embodiment, as shown in FIG. 1, a consumer visits the website of a company and shops for products or services. In this process, the consumer chooses items that they are interested in or shopping for. Identification information about the items selected is saved to a separate database or file for retrieval via a social networking site or engine.

The consumer is able to post one or more of these items to the social networking site or engine from the company's website by logging in with their social network user name and password. The items or products selected appear in the consumer's status update, and can be posted for viewing by their network of friends. A link to the system of the present invention also may be provided. By clicking on the link, the friends of the consumer can accept and visit the application. The application may then allow the friends to view the product or item selections on which the consumer is seeking feedback. The friends may submit comments or observations about the available selections, and also may be able to vote for the product or products that they prefer, or provide a rating on a particular product or products.

All voting and comments may then be posted back to the consumer's social networking homepage, tallied within the application, as the user's status update, and back to the seller's product website, along with the original message and link. The voting and messages may be logged or stored in a database. The above process may take place prior to the consumer actually making a purchase, and thus may be used to solicit input from the social network of friends prior to making a purchase. Alternatively, the process may take place after a purchase is made.

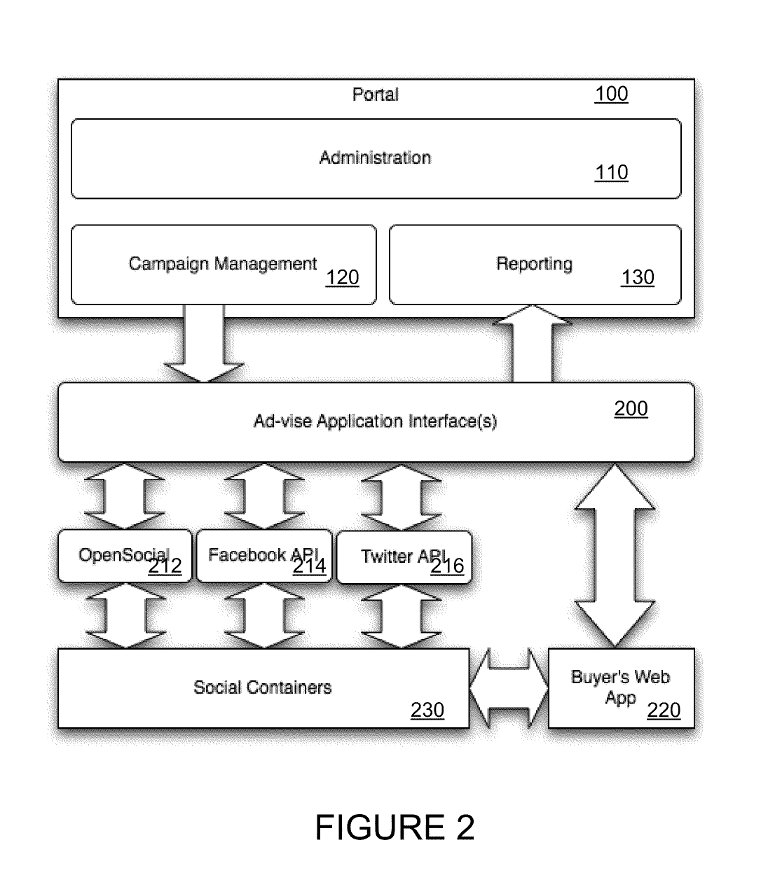

In another embodiment, as shown in FIG. 2, a system of the present invention comprises three major components:

System Portal 100—A web-enabled application for administration 110 of the system, and also providing campaign management 120 and reporting 130 functions.

Application Interface 200—The service-level application interface that permits the portal administration and campaign management functions to interact with a variety of social container APIs 212, 214, 216 and the consumer's web applications 220.

System Application—The end-user interface and application that interacts with both the social containers 230 (e.g., MySpace, Facebook, Bebo, etc.) and the consumer's web applications 220.

In one embodiment, the Portal 100 is a role-based, web-enabled application that provides a business or company, and administrators of the system, several functions to interact with and control the system. The system is security-enabled, with different levels of access (i.e., role-based permission).

The administration function 110 is the primary means for administrators of the system to interact with and control the system, and carry out administrative functions. These functions include provisioning, user administration, administrative reporting, and administrative campaign management.

The provisioning component of the system allows an administrator to set up and maintain a number of businesses or companies as clients or customers of the system (for versions of the system where an entity provides services through the system to multiple businesses or companies). In an alternative embodiment, a single business or company may implement a form of the system independently. In one embodiment, interaction is through a web-based interface. This component allows the administrator to establish all of the settings for a business or company. Specific functions and capabilities include, but are not limited to: adding new businesses; deleting businesses; changing settings; adding a sub-business (for roll-up and separated disparate reporting capabilities); maintaining customer contact information; maintaining customer accounts payable information; establishing and maintaining customer pricing information; maintaining graphical interface specifications and adding, modifying or deleting business campaign information.

The user administration component provides an administrator with management functions related to individual users of the system (such as employees of a business or customer that is using the system). When a new business, organization or customer is added to the system, the administrator will have the ability to also set up individual customer users of the system. Specific functions and capabilities include, but are not limited to: adding users to an organization or business; changing user information; deleting users; setting or changing passwords; assigning roles; and changing detailed permissions by user or by role.

The administrative reporting component provides the administrator (and other users with authority) the ability to audit and measure use of the system and all applications. This permits an administrator to review errors within the system, determine problems, solve problems and existing issues, audit the system, audit customer billing, and review system activity. Specific functions and capabilities include, but are not limited to: automated reporting and notifications via email or otherwise; error logging and reporting; client and customer accounting; application performance monitoring (e.g., detecting 404 errors, system response times, and other errors); account auditing; and global system and client roll up reporting (i.e., information across all accounts). In one embodiment, this component provides a modifiable dashboard with all system interactions and key performance indicators.

The administrative campaign component provides for administrator access to, and management of, a business customer's campaign implementation (as described in more detail below). In some cases, a business will not desire to manage a campaign itself, or will require another entity, such as that hosting an embodiment of the system, to manage a campaign. In addition, there may be a need for an administrator to manage or change campaign settings and assets for a business, even when the business is managing its own campaigns. Specific functions and capabilities include, but are not limited to: tie-in, correlate, and manage a customer's external systems integration; add, modify, and delete digital assets, rich media, or other components associated with a campaign; create or modify triggers or thresholds based upon time or specified measurements; manage general campaign settings (e.g., campaign name, dates, etc.); maintain marketing incentives utilized in the system; integrate marketing automation and multi-touch campaigns; and integrate and manage customer relationship management (CRM) connections for lead generation and management.

The campaign management component 120 is used by a business or other customer for specific management of a marketing or advertising campaign for a particular product or brand. It provides the business customer an easy way to manage assets, information, settings, graphical user interfaces and marketing-related tasks within the campaign. Specific functions and capabilities include, but are not limited to: asset management (e.g., product information, graphical and rich media assets); general campaign and product settings and setting maintenance; integrated marketing campaigns (e.g., incentives, discounts, etc.); creation and modification of triggers, call to actions or thresholds based on time or specified measurements; and management of settings for integrations with external systems.

The reporting component 130 permits a business or other customer or use to obtain detailed user information as well as broad, consolidated summaries and views. Pre-determined and customizable reports forms are provided. Reports may be in graphic form as well, and the system may provide the ability to “drill down” into the data through the report itself. Specific functions and capabilities include, but are not limited to: configurable dashboards; dynamic bar, line, scatter, pie and funnel charts; data filtering; drill-down detail for each report; sortable columns; customizable reports; and savable, sharable reports. Metric categories include, but are not limited to: adoption rates by market segments and consumer profiles; social activity (e.g., commenting, sharing, fans, login frequency, and triggered actions); market segmentation (e.g., by number of friends, consumer profiles by demographics, geography); application virility (e.g., user invites and adoption of invites and influences); product engagement and loyalty (e.g., user activity by product and/or product feature, and measure over time); campaign measurement (e.g., adoption, usage, social activity by campaign); conversion/events (e.g., determine users converting into leads, closed deals and web events); application performance (e.g., component use and interaction of application features); and cost (e.g., running total of program or campaign cost with ROI tool, conversion funnel).

In one embodiment, the reporting component further comprises reporting APIs that provide analytic data and the like to specific business marketing analytics tools (e.g., Omniture). These may be integrated into business or customer measure and analytics tools, or third party tools.

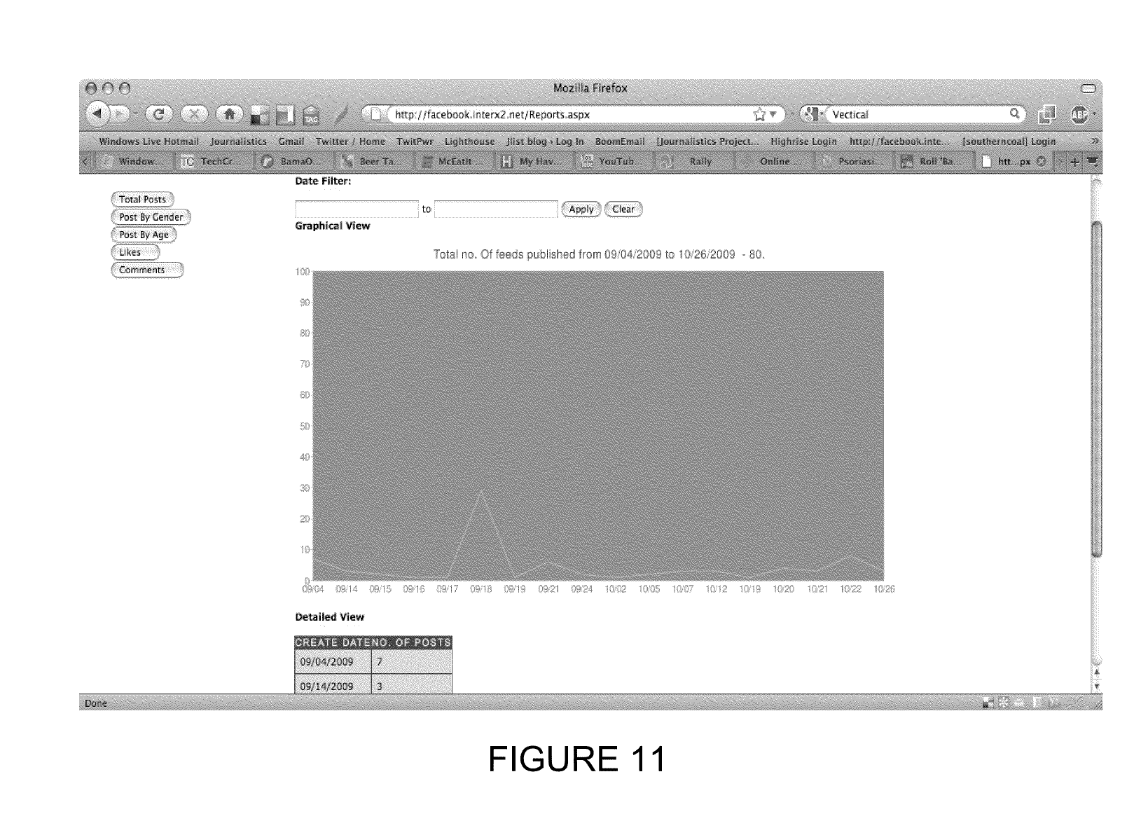

In one exemplary embodiment, as seen in FIG. 11, a business can use a system reporting portal where they can view end user applications and interactions as well as specific posts and comments. Filters may be used to provide an in-depth view of the demographic and sociographic data associated with each report. Filter parameters include, but are not limited to, date, age, gender, location and number of friends. Examples of report types include, but are not limited to, number of posts, number of likes, number of comments, number of click-throughs for the call-to-action, specific posts by end users, and specific comments by posts by end users.

The application interface 200 provides the interface between the core of the system and various touch points. In one embodiment, the application interface provides a dynamic service-based interface that can be changed over time and driven by database interaction. The interface provides a flexible contact with containers (i.e., social networks) as well as business web sites and applications.

In one embodiment, a variety of specific APIs may be used to interface with the application interface. For example, the OpenSocial API 212 is a common application interface that allows sharing of data across social networks and the Internet. The system of the present invention can use the OpenSocial API as an extension into a large number of social containers on the Internet, including, but not limited to, the following: LinkedIn; MySpace; Netlog; Yahoo!; Webjam; Friendster; FanBox; ATutor; and Google Friend Connect. Similarly, the Facebook API 214 permits integration with the social Facebook network.

The Twitter API 216 provides a different type of interaction, as Twitter is not a social network container application, and does not facilitate applications. The system thus allows for end user consumers to share a link via their Twitter application to ask followers to provide advice about a possible buying decision. The system then takes the user to their Twitter account and pre-populates the “tweet” with a statement and a shortened URL to the system's comparison application splash page. An example of such a process comprises the following steps:

1. Alice browses the Mohawk website catalog for new carpet.

2. She finds the Mohawk SmartStrand and decides that she needs some advice on the value versus price of the product.

3. Alice clicks on the “Get Advice via Twitter” link on the product page.

4. Alice then is taken to an application landing page that she logs into with her twitter info (OAuth). This landing page gives her a preview of the application.

5. Once she clicks “Send to Twitter”, the system application takes Alice to her twitter page with the “tweet” pre-populated with a statement and a shortened URL to the system application, e.g., “Trying to decide on carpet—what do you think of this? http://ow.ly/Rsd4G”.

6. Followers of Alice see the twit and click on the link, which takes them to a splash page for the product comparison. Upon attempting to make a rating, comment, or suggestion, they are asked to click a link to log in through their twitter app (OAuth).

7. The followers leave feedback for Alice that she can log into the same URL later to access the results.

8. Alice can also check the reviews left by both friends and family as well as other users of the application on the Mohawk website.

The system application component interacts with the target consumer or end-user. This interaction primarily is through the business customer's touch points, such as its website, marketing splash page, product configuration, or similar application. The consumer typically initiates the application within their chosen social network (e.g., Facebook). The system application allows the target consumer's friends to provide recommendations or advice about the product they are considering.

In one embodiment, the primary access point to the system application is a button or a link on the business website or application. This application button directs the end-user consumer to a social networking splash page that asks them to install the application and notify friends. Once installed, the application will show up in the recent status update as well as provide the ability to further notify friends. Once notified, friends have the ability to provide feedback or advice about the consumer's possible purchase. This feedback can be referenced at any time by the consumer, ultimately driving them to the purchasing decision.

Thus, for example, a consumer may wish to use the system application to obtain friend feedback or advice about a single product, or to compare two or more separate products with each other and get feedback or advice about each product. Each of these scenarios will have different consumer interactions from consumer discovery of the product, as well as the resulting application in the social network.

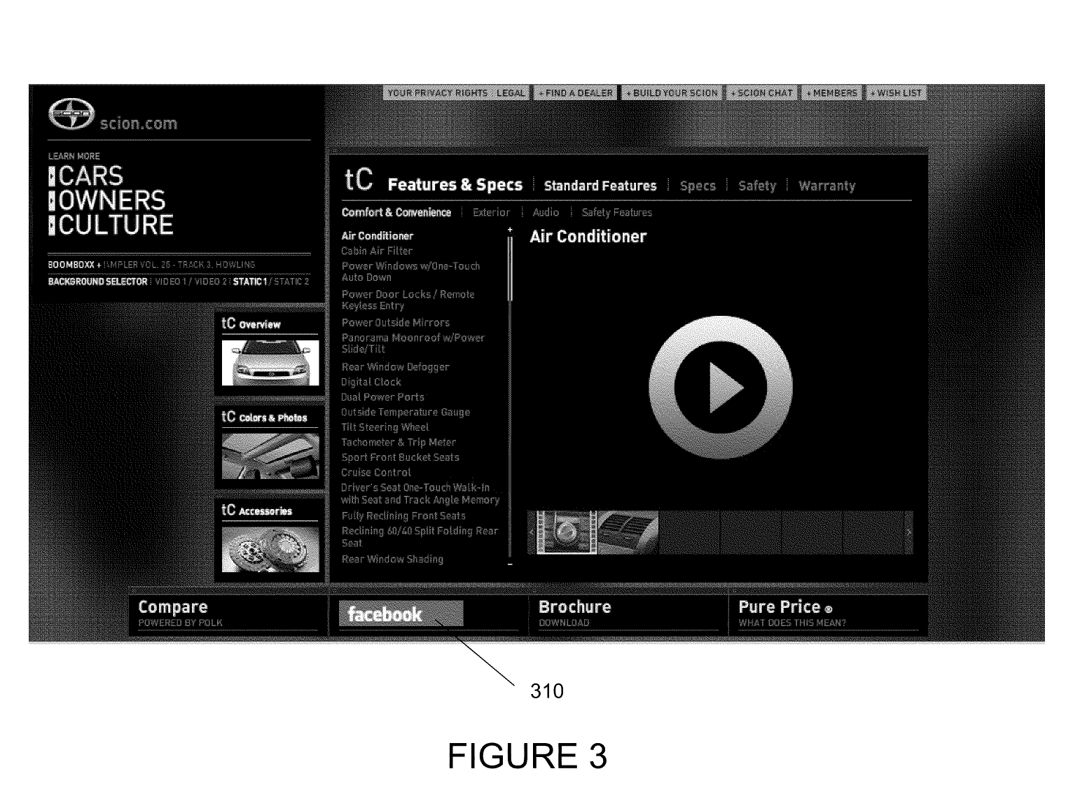

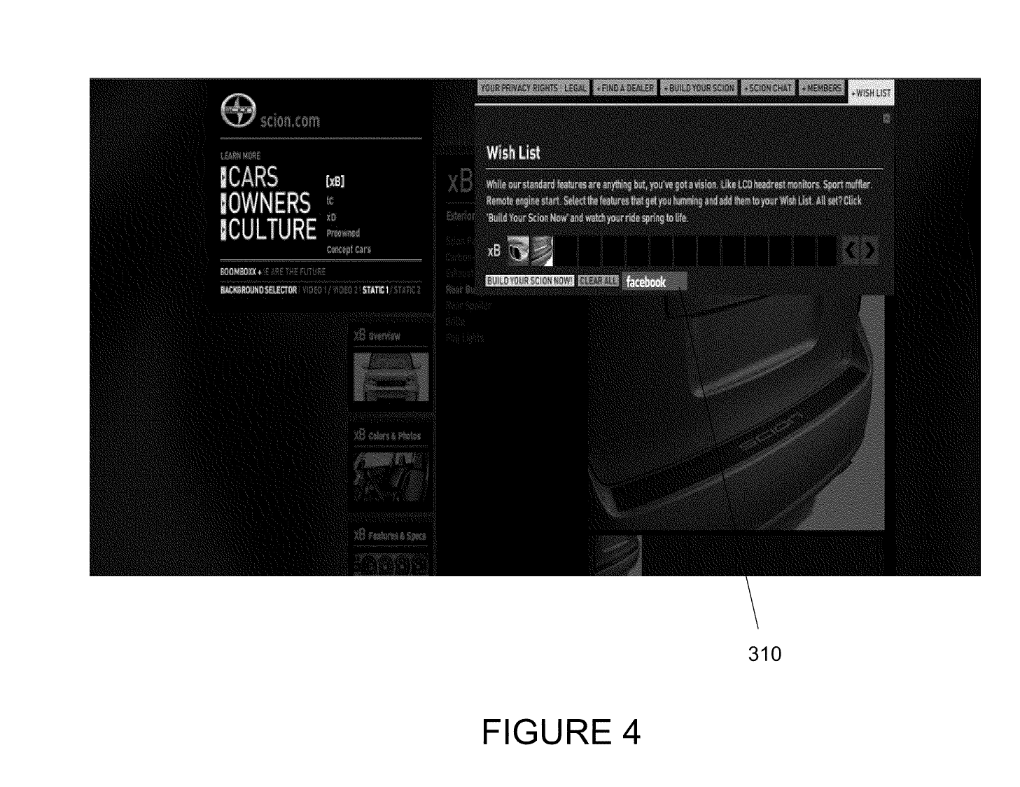

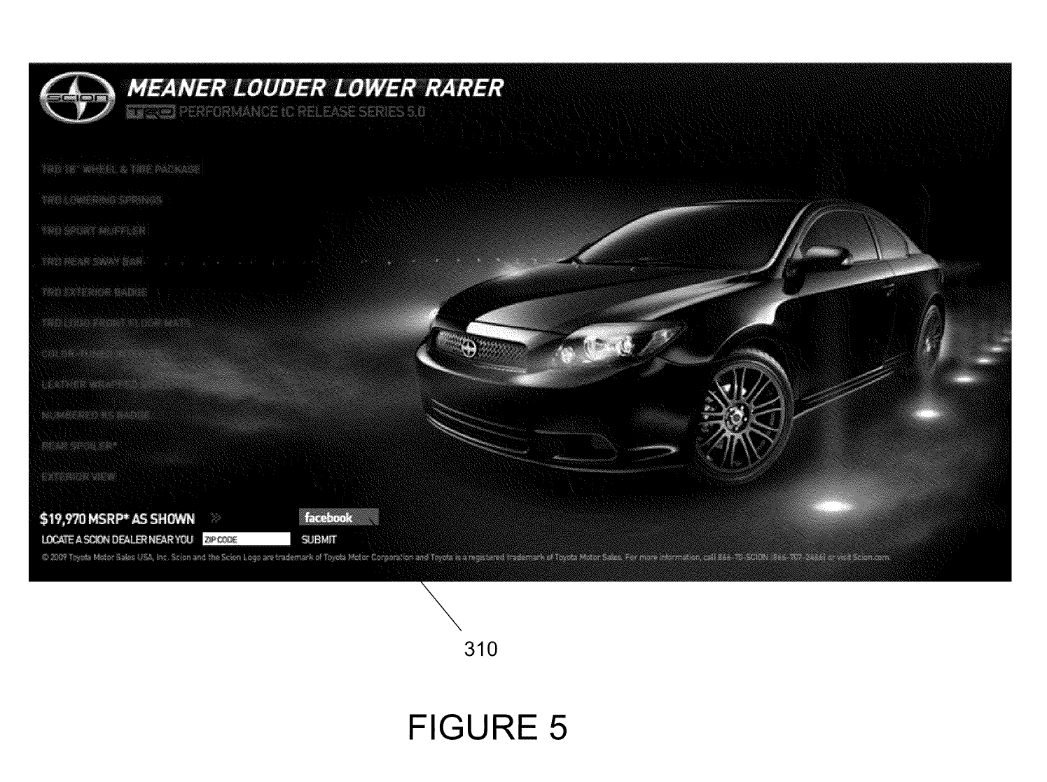

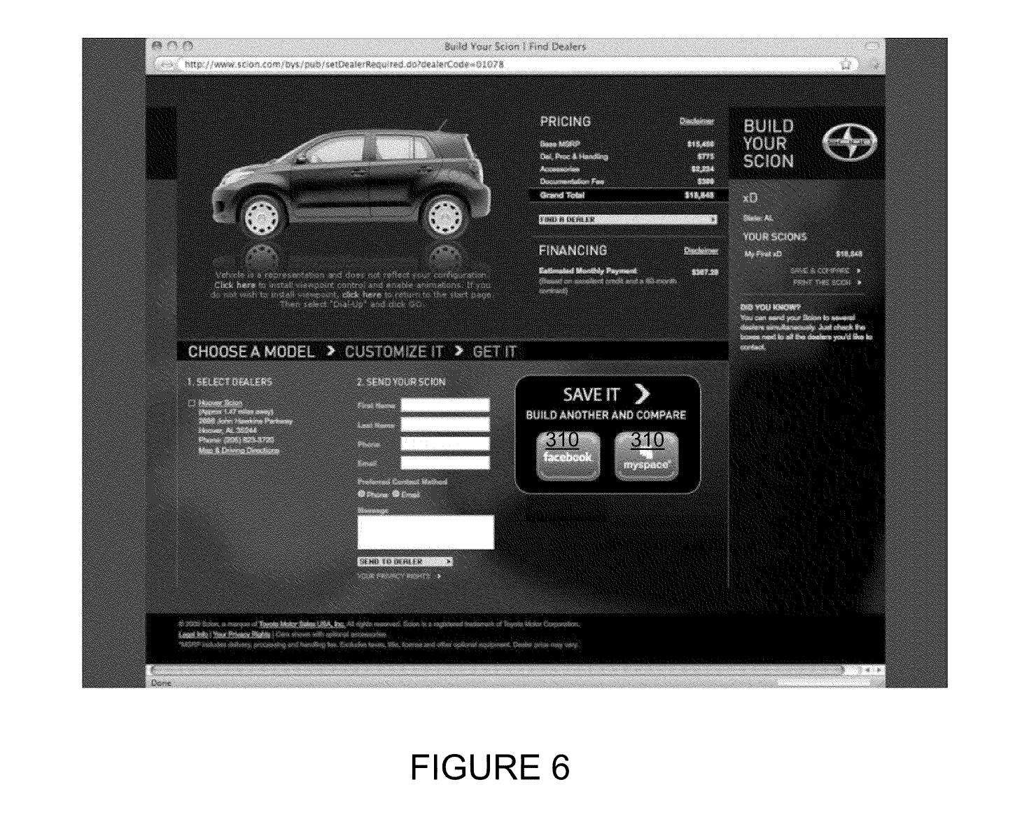

For the single product scenario, the system may have a very open level of interaction on the business website and in its applications. In general, the application may be placed anywhere that consumers interact with product brand or marketing campaigns (i.e., touch points). Possible touch points include, but are not limited to, the following: website product catalog; marketing campaign splash-page; new product launch-page; featured product pages; incentive or sales based pages; shopping carts; email marketing campaigns; wish-listing application; and product configurator. Examples of touch points with an application button 310 taking the consumer to Facebook or MySpace include a business product catalog (FIG. 3), a wish-list application (FIG. 4), a product feature page (FIG. 5), and a product configurator (FIG. 6). Regardless of the initial application access point, a consumer will be able to share on their profile, update their status, and notify friends.

An example of a consumer interaction with a one-product application comprises the following steps:

1. Alice visits mohawk.com product gallery.

2. After exploring the gallery, Alice dials in on a SmartStrands product she is considering.

3. Alice notices a “Get Advice on Facebook” button on the page and decides to click.

4. The application takes her to an application Facebook splash page with a highlight of what gets posted to her profile (after login to the application and approval of application access to data). This is, in essence, a preview of the application.

5. The options available to Alice are post to profile and notify friends.

6. The application is installed on the profile and status is updated. Messages are sent to friends to notify (as selected by Alice).

7. Friends interact with the application and provide recommendations.

8. Alice checks the application at her convenience to see the results and chooses the call-to-action to make the purchase.

9. Alice can also check the reviews left by both friends and family as well as other users of the application on the Mohawk website.

A delayed login may be used to allow the user to view the application before logging in, and installing and interacting with the application. This allows friends to see the application before installing themselves, as well.

Alternatively, the above process may be modified to include a friend's recommendation for another product:

1. Alice's friend Joe decides to click the call-to-action to choose another product to suggest to Alice.

2. The application links Joe to the buyer's website where Joe chooses another product and hits the suggest button.

3. Alice checks the application at her convenience and decides to purchase the suggestion by Joe by clicking the call of action to purchase next to Joe's suggestion.

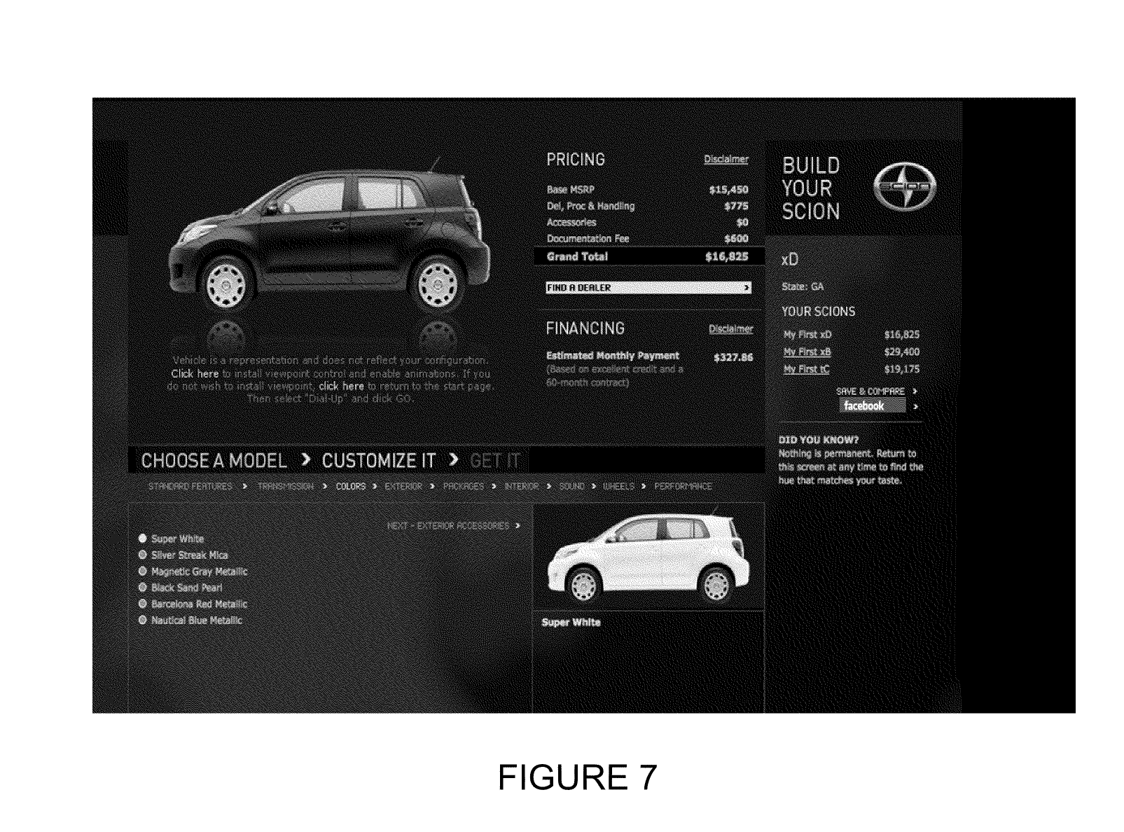

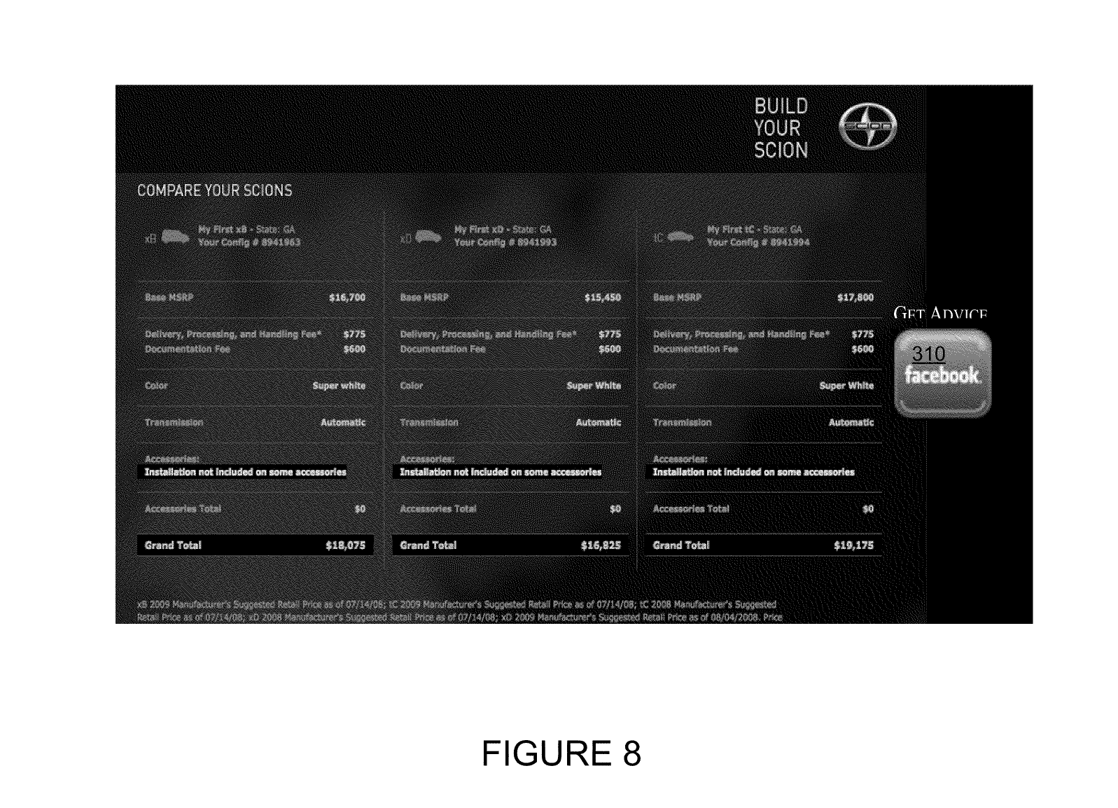

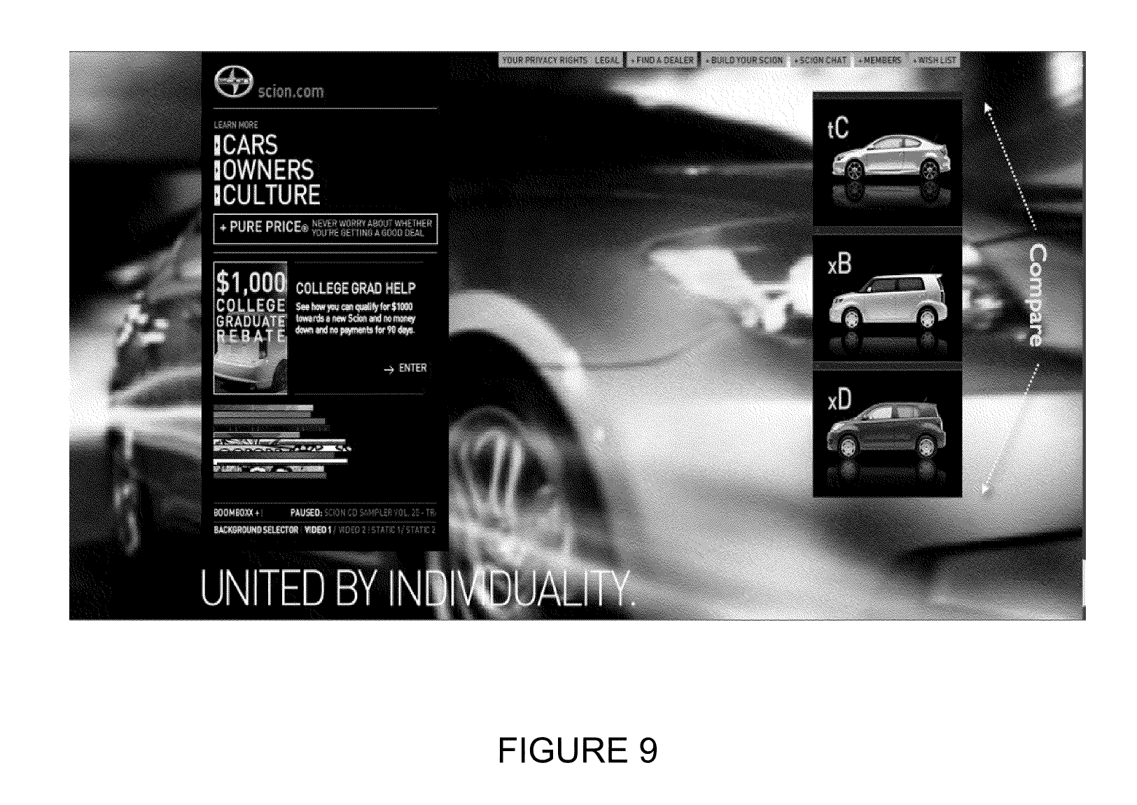

In a two (or more) product comparison scenario, specific places of the business application typically list multiple products, providing the end user consumer the ability to compare one or more products and get feedback from friends through the system. Possible touch points include the above touch points listed for the single product scenario, and, in addition, product class comparison pages, and incentives or sales-based campaign applications with multiple products. Examples of touch points with an application button 310 taking the consumer to Facebook or MySpace include a shopping cart page (FIG. 7), a product configurator (FIG. 8), and a product class comparison (FIG. 9). As mentioned above, regardless of the initial application access point, a consumer will be able to share on their profile, update their status, and notify friends.

An example of a consumer interaction with a multi-product application comprises the following steps:

1. Alice visits mohawk.com product gallery.

2. After exploring the gallery, Alice decides that she is interested in two different products and is having a hard time deciding which to buy.

3. While using the site's product comparison application, she notices that she can get advice from friends through a button on the application.

4. Alice notices a “Get Advice on Facebook” button on the page and decides to click.

5. The application takes her to an application Facebook splash page with a highlight of what gets posted to her profile (after login to the application and approval of application access to data). This is in essence a preview of the application.

6. The options available to Alice are post to profile and notify friends.

7. The application is installed on the profile and status is updated. Messages are sent to friends (as selected by the Alice).

8. Friends interact with the application and provide recommendations on the two products.

9. Alice checks the application at her convenience to see the results of the comparison of the two products, and chooses the call-to-action to make her purchase.

10. Alice can also check the reviews left by both friends and family as well as other users of the application on the Mohawk website.

As above, delay login can be used. Similarly, friends can suggest alternative products:

1. Alice's friend Joe decides to click the call-to-action to choose another product to suggest to Alice.

2. The application links Joe to the buyer's website where Joe chooses another product and hits the suggest button.

3. Alice checks the application at her convenience and decides to purchase the suggestion by Joe by clicking the call of action to purchase next to Joe's suggestion.

4. Alice can also check the reviews left by her social network as well as other users of the application on the Mohawk website.

The system's comparison application has several different features and capabilities. After initiating the application on the user's respective social network, friends and followers have the opportunity to interact with the business's brand by providing feedback to the consumer on the products for which they are seeking advice. This application may have a different look and feel based upon the number of products for which the consumer would like to get advice. The application may contain some key calls-to-action for both consumers and their friends. The calls-to-action will lead them down the sales process and encourage them to install the application themselves, engage with the business brand, and share the application virally with friends.

Product information about the product or products in question is displayed to the end users with appropriate rich media (such as pictures and videos) and links to product pages. Also provided are product specifications and a list of product features relevant to the comparisons. This product information may combine to allow end users to make appropriate comparisons for the products.

Upon installation of the system application to the consumer's profile, the consumer will be given the option to notify friends of the application via system messages within the social network. The option to notify all friends will be given, as well as the capability to select which friends to notify about the application.

Upon installation (and with other interactions), the installing consumer's status will be updated to notify friends that they are looking for feedback on the selected items. For each interaction session with the application, a user's status will be updated with the appropriate information and also will provide a link for others to use to interact. This feature will keep the application fresh on the minds of users, and influence friends who are on the network. These updates will not only occur for the user who installed the application but also for users who have interacted (i.e. voted, commented, etc.) with the application. The status will also be updated once the end user decides to take action in the call-to-action area of the application.

In another exemplary embodiment, the comparison application allows users to vote for the product that they recommend. These votes will be kept as a tally and can be viewed by everyone that uses the application. Users will be particularly interested to see who voted what, so the application supports viewing of individual responses by everyone.

In addition to voting, the application allows users to rank the products on some appropriate scale. This scale represents how much the end users like the product, and the consumers' view of the product. As with voting, the application supports viewing of the rankings by user.

In order to provide personalized specific feedback about the product, in one exemplary embodiment users have the capability to provide feedback in the form of comments. While users may have the capability to comment on status updates, they will also have the ability to comment directly within the application. In one embodiment, threaded comments and subscription to comments is supported. In many instances, users will wish to respond back to others' comments in addition to the consumer's comments. Threaded comments facilitate ease of reading of these conversations. Comments may be subscribeable via system messages in the social media container. This allows users to be notified, including the consumer, when their comments are responded to.

In one embodiment, the user has the capability to view the social networks reviews on the seller's product website. These reviews will contain all the same data available via the application on the social network to include but not limited to; reviews, specific comments, ratings and/or voting.

In one embodiment, the application uses specified reminders to “bump” or “nudge” the consumer to remind them that the application is still open for feedback. This reminder may be a system-generated message to the consumer.

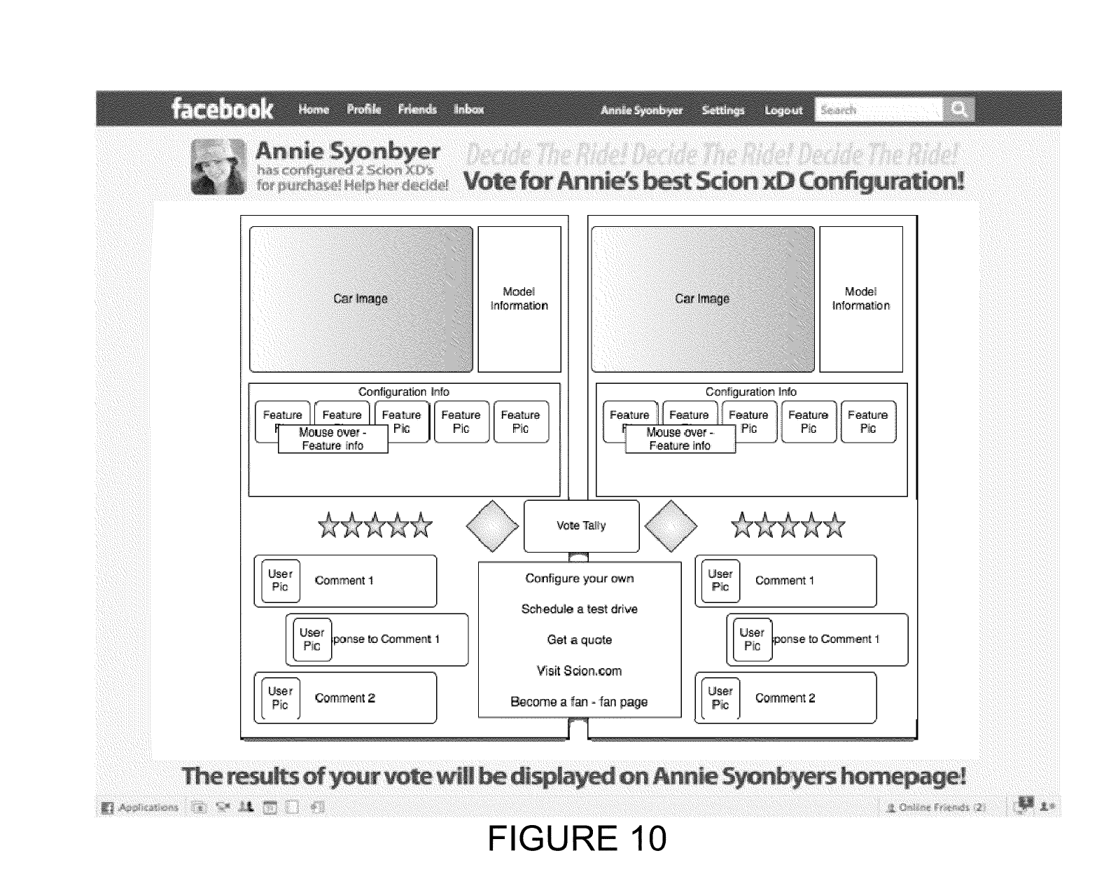

In yet another exemplary embodiment, as seen in FIG. 10, the system comprises a call-to-actions section that encourages users to interact, install the application, share with friends, and take the next step in the buying process. These include, but are not limited to, the following actions:
purchase the product;
take the next step in the buying process (i.e., test drive, schedule meeting or appointment, and get a quote);
visit the business website or product catalog;
become a fan in the social networking application;
join a group or a community for the product;
install the application;
configure a product;
suggest a different product;
change products;
subscribe to business's marketing email list; or
contact business.

In one embodiment, the system provides users the option of suggesting an alternative product instead of voting for one of the choices presented. The system may allow users to click a link back to the business website or application to choose an alternative product. Once the product is identified, they can click a button to “suggest” that product, and post a comment back to the application with a link or representation of the product.

There may be some situations where the consumer will wish to change the products they are asking for feedback upon. The consumer can go back out to the business's catalog or application and choose a different product to replace the product they are requesting feedback upon. Under the circumstance where multiple products are being considered, the user can replace one of the products (at a time) for feedback.

In another exemplary embodiment, the system may provide a number of supplementary product features. For example, a business may use the system to continue a level of communication with the consumer, including posting a picture of the consumer with their purchase to the application, following up with up-sells or after market items, and offering marketing incentives or promotions to the user.

It is usually preferred in the buying process that a specific item is offered to the end user directly from inventory. In some businesses, such as car dealerships, that may be a specific configuration of a product that would allow the user to create an emotional tie to a product item (as opposed to the product itself). As a call-to-action, this feature of the system could encourage a consumer to take the next step in the buying process—moving from a product or product category to a specific item. This feature requires integration with the business's inventory system and allows the consumer to pick a specific product item on which to obtain feedback.

Similarly, the ability to offer sales, discounts or other marketing incentives is very powerful in encouraging the user to take the next step of the sale process. By integrating with a business's campaign management systems and/or allowing independent campaigns in the system, business can automate the marketing process by offering the consumer an incentive (e.g., discounted or reduced price, etc.) to purchase through the system application. The incentive, or amount of the incentive, may be based upon a pre-determined threshold or event.

In another embodiment, the system may be a branded custom version for a particular business. This permits businesses to promote the application independently as well as to make the application available through browsing and search in the application “store” on social networks. Branding the application gives the application a name for the business and makes the application independent. This branded application could serve as an application feature or a professional services engagement.

In order to provide a context for the various aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), network PCs, minicomputers, mainframe computers, embedded systems, distributed computing environments, and the like.

Embodiments of the invention may be implemented in the form of computer-executable instructions, such as program code or program modules, being executed by a computer or computing device. Program code or modules may include programs, objections, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices.

In one embodiment, a computer system comprises multiple client devices in communication with at least one server device through or over a network. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, Javascript, .Net, ASP.net and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for advertising, comprising:
one or more computing devices electronically connected to a network, at least one of said computing devices comprising a microprocessor coupled to a memory, wherein the microprocessor is programmed to:
prompt a first individual on the network to select one or more products on which to seek input; and
prompt at least one other individual to provide input on the one or more products;
where the first and at least second individuals are members of the same social network.

2. The system of claim 1, wherein the system prompts two or more other individuals to provide input on the one or more products.

3. The system of claim 1, wherein the first individual selected the at least one other individual who is prompted to provided input on the one or more products.

4. The system of claim 1, wherein the input sought is a comparison of two or more products.

5. The system of claim 1, wherein the input sought is a vote.

6. The system of claim 1, wherein the prompting for input is done through the social network.

7. The system of claim 1, wherein the input sought is a suggestion for an alternative product.

8. The system of claim 1, further wherein the microprocessor is programmed to receive the input.

9. The system of claim 8, further wherein the microprocessor is programmed to analyze and store the input received.

10. The system of claim 9, wherein the system provides reports on the products and input received.

11. A computer-implemented method for advertising, comprising the steps of:
prompting a first individual in a social network to select one or more products on which to seek input;
prompting at least one other individual in the same social network to provide input on the one or more products; and
storing the input in a computer database electronically connected to one or more computer servers electronically connected to a network.

12. The method of claim 11, wherein two or more other individuals are prompted to provide input on the one or more products.

13. The method of claim 11, wherein the first individual selected the at least one other individual who is prompted to provided input on the one or more products.

14. The system of claim 11, wherein the input sought is a comparison of two or more products.

15. The system of claim 11, wherein the input sought is a vote.

16. The system of claim 11, wherein the prompting for input is done through the social network.

17. The system of claim 11, wherein the input sought is a suggestion for an alternative product.
